(19) United States
(12) Patent Application Publication
(10) Pub. No.: US 2026/0298618 A1
(43) Pub. Date: Oct. 1, 2026

(54) CHROMATIC POINT SENSOR MEASURING APPARATUS

(71) Applicant: MITUTOYO CORPORATION, Kanagawa (JP)

(72) Inventors: Ryusuke KATO, Kanagawa (JP); Megumi OTOSE, Tokyo (JP)

(73) Assignee: MITUTOYO CORPORATION, Kanagawa (JP)

(21) Appl. No.: 19/573,835

(22) Filed: Mar. 20, 2026

(30) Foreign Application Priority Data
Mar. 25, 2025 (JP) 2025-049935

(51) Int. Cl. G01B 11/02; G01B 11/00

(52) U.S. Cl. CPC G01B 11/022; G01B 11/007; G01B 11/026

(57) ABSTRACT

A CPS (chromatic point sensor) measuring apparatus includes a CPS probe acquiring distance information to a workpiece, a main body that moves the probe, and a computer calculating workpiece shape information based on detection signals. The probe has a chromatic aberration lens that converts light passed through an aperture into focused light having axial chromatic aberration to emit toward the workpiece. The probe forms a measurement spot of wavelength depending on the distance on the workpiece, condenses reflected light of the measurement spot with the lens and focuses the reflected light at the aperture to detect it, irradiates illumination light from the light source for observation with the lens to an illumination area on the workpiece, and guides the reflected light to the camera for observation via the lens. The computer displays a mark at a position of the measurement spot on the observation image of the camera.

### RELATED APPLICATIONS

This application claims the priority of Japanese Patent Application No. 2025-049935 filed on Mar. 25, 2025, which is incorporated herein by reference.

### FIELD

The present disclosure relates to a chromatic point sensor (CPS) measuring apparatus that measures a surface shape of a workpiece in a contactless manner.

### BACKGROUND

In general, depending on how a workpiece is disposed relative to a measuring probe or how the position or posture of the measuring probe is set relative to the workpiece on a table at the start of measurement, measurement time may be shortened or get longer, and the number of operations of the measuring probe may also be affected. It is the same when a minute uneven shape is microscopically measured, and a camera that acquires an observation image of the workpiece through an objective lens is disposed to capture a measurement target on a display apparatus, so that visibility of a measurement area on the workpiece can be enhanced, and it is useful for disposing the workpiece relative to the measuring probe suitably.

In measuring apparatus using a CPS probe, there are those that a camera for observation is mounted to the CPS probe (e.g., Patent Literatures 1 and 2). The CPS probe usually configures a confocal optical system by an aperture and a chromatic aberration lens, and converts light of a CPS light source (e.g., light in a wavelength region of 450 to 660 nm) to a focused light having axial chromatic aberration with the confocal optical system to irradiate a workpiece surface. Accordingly, a measurement spot formed of light having a wavelength depending on the distance from the probe is formed on the workpiece surface. The CPS probe is configured to guide a reflected light of the measurement spot to the CPS detector again via the confocal optical system, and the CPS detector is configured to disperse light for each wavelength and perform light detection, so that distance information from the probe to the workpiece is acquired.

According to FIG. 4 of Patent Literature 1, a dichroic mirror provided between an aperture and a chromatic aberration lens merges an illumination light (e.g., wavelength of 680 nm) from a light source for observation to an optical axis of the CPS probe, irradiates the workpiece via the chromatic aberration lens, and illuminates an illumination area on the workpiece. The dichroic mirror has a characteristic of transmitting through a white light of 450 to 660 nm from the CPS light source, and reflecting the illumination light of 680 nm. A reflected light from the illumination area of the workpiece reaches the dichroic mirror via the chromatic aberration lens, reflects off the dichroic mirror, is guided to an image sensor to acquire an observation image. The observation image of the measurement area is expressed with shading of light of 680 nm.

In the optical configuration of Patent Literature 1, however, the measurement spot formed on the workpiece is light having a wavelength within a range of 450 to 660 nm, so that a reflected light from the measurement spot transmits through the dichroic mirror. Therefore, there is a problem that although the measurement spot is formed on the illumination area on the workpiece, the measurement spot is not captured on the observation image of the measurement area by a camera for observation.

Next, according to FIG. 1 of Patent Literature 2, a beam splitter provided between an aperture and a chromatic aberration lens transmits a part of an illumination light (e.g., green light, 531 nm) from a light source for observation and reflects the rest, so that the reflected illumination light merges to an optical axis of the CPS probe, and illuminates an illumination area on the workpiece via the chromatic aberration lens. The reflected light from the illumination area reaches the beam splitter via the chromatic aberration lens, and a part of the reflected light is branched from the optical axis of the CPS probe to be guided to the camera for observation. The beam splitter transmits a part of a white light from the CPS light source and reflects the rest, so that the measurement spot by the specific wavelength within the wavelength range (450 to 660 nm) of the white light from the CPS light source is formed on the workpiece.

In such observation using a beam splitter, a part of the reflected light from the measurement spot on the workpiece is also guided to the camera for observation, so that the measurement spot is captured on the observation image. Due to the characteristic of the CPS probe, however, not only light having a wavelength that focuses on the workpiece surface (light that forms the measurement spot), but also light of other wavelengths that does not focus on the workpiece surface enters the camera for observation via the beam splitter, so that the measurement spot that is captured on the observation image becomes unclear (vague image).

Accordingly, in Patent Literature 2, it is configured to provide a narrowband filter in front of the camera, such that only light having a wavelength (531 nm) used in imaging among the reflected light is selected and guided to the camera. However, in order to make the camera for observation to acquire the observation image of the measurement area including the measurement spot, the focal plane of the camera must be adjusted to coincide with the height at which the wavelength of the narrowband filter (531 nm) forms the measurement spot.

### PRIOR ART LITERATURES

### Patent Literature

PATENT LITERATURE 1: Japanese Unexamined Patent Publication No. 2018-66670 A
PATENT LITERATURE 2: Japanese Unexamined Patent Publication No. 2023-20888 A

### SUMMARY

A chromatic point sensor (CPS) measuring apparatus according to one aspect includes a chromatic point sensor (CPS) probe that optically acquires distance information to a workpiece; a measuring apparatus main body that moves the CPS probe installed in a probe head relatively to the workpiece; and a computer that processes detection signals from the CPS probe to calculate workpiece shape information. The CPS probe is provided to have an aperture that passes through light from a CPS light source, and a chromatic aberration optical element that converts the light that passed through the aperture into focused light having axial chromatic aberration to emit the focused light toward the workpiece, and form a measurement spot of wavelength depending on a distance to the workpiece on the workpiece surface that is positioned within a range of axial chromatic aberration of the focused light. The CPS probe is also provided to condense reflected light of the measurement spot with the chromatic aberration optical element and focus the reflected light at the aperture, and then guide the reflected light to a CPS detector such that the CPS detector outputs detection signals. And the CPS probe is also provided to irradiate illumination light from a light source for observation to an illumination area on the workpiece surface with the chromatic aberration optical element, and guide reflected light of the illumination area to a camera for observation via the chromatic aberration optical element. The computer functions as a mark displaying means that displays a mark at a position of the measurement spot on an observation image acquired by the camera for observation.

### DESCRIPTION OF THE DRAWINGS

FIG. 1 shows a configuration example of a CPS probe.

FIG. 2 shows a configuration example of a CPS measuring apparatus.

FIG. 3A to 3E are explanatory diagrams of a method for determining a mark position.

FIG. 4F to 4H are explanatory diagrams of a method for determining a mark position.

FIG. 5A to 5D are explanatory diagrams of a method for evaluating positional shift between a measurement spot and a mark.

FIG. 6A to 6C are explanatory diagrams of a method for correcting positional shift of the mark due to optical axis misalignment of the CPS probe and a camera for observation.

FIG. 7 shows another configuration example of the CPS probe.

### DESCRIPTION OF EMBODIMENTS

In the following, embodiments of the chromatic point sensor (CPS) measuring apparatus according to the present application are described with reference to the drawings. Each embodiment merely shows an example or aspect, and ranges of numerical values and functions, and situations for use are not limited by these examples. Each embodiment can be suitably used in combination within a scope consistent with the effects based on the configuration.

### First Embodiment

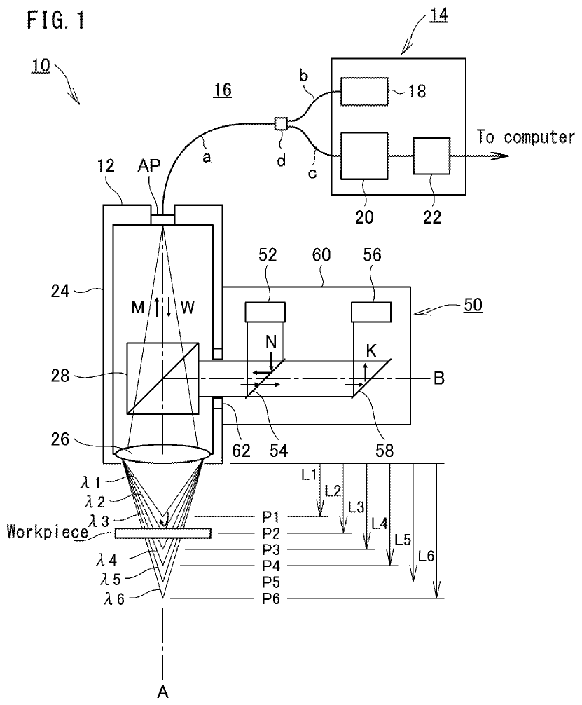

FIG. 1 schematically shows a configuration example of a CPS probe 10. The CPS probe 10 is detachable to a probe head of a CPS measuring apparatus, and is used for optically acquiring distance information to one point of a workpiece on a table of the CPS measuring apparatus. The CPS probe 10 has a probe main body 12, a light source/detection unit 14, and an optical fiber portion 16 that connects the two.

First, the light source/detection unit 14 is described. The light source/detection unit 14 has a CPS light source 18, a CPS detector 20, and a signal processing circuit 22. The CPS light source 18 is provided with a white LED that emits white light W. The white light W contains a wavelength region that continues from a blue wavelength region to a red wavelength region, e.g., visible light of 500 to 700 nm; however, a specific wavelength region is not limited. Instead of the LED, a mercury lamp may also be used.

The optical fiber portion 16 is configured with multiple optical fibers (a to c), and has an optical fiber (a) connected to the probe main body 12, an optical fiber (b) connected to the CPS light source 18, and an optical fiber (c) connected to the CPS detector 20, for example. These optical fibers (a to c) are connected to a fiber splitter (d). The white light W from the CPS light source 18 is guided to the probe main body 12 by the optical fiber portion 16. Moreover, measurement light M from the probe main body 12 is guided to the CPS detector 20 by the optical fiber portion 16. Instead of the fiber splitter (d), an optical fiber coupler may also be used.

The probe main body 12 has a pen-shaped housing 24 having a longitudinal direction as an optical axis A, and a chromatic aberration lens 26 provided inside this housing 24. At an end of the housing 24, an irradiation port of which the white light W from the chromatic aberration lens 26 is irradiated to the workpiece. At a back end of the housing 24 (an end on the probe head side), a connection port of the optical fiber (a) is provided, and the white light W is irradiated from the connection port into the housing 24. This connection port is called as an aperture (AP) herein.

The chromatic aberration lens 26 is an example of the chromatic aberration optical element, and is a lens or a group of lenses designed for chromatic sensors. The chromatic aberration lens 26 converts the white light W emitted from the aperture AP into a focused light having axial chromatic aberration, and irradiates the focused light from the irradiation port to the workpiece. The chromatic aberration lens 26 has a characteristic of converging the white light W that enters the probe main body 12 to a focus point P on the optical axis A depending on a wavelength λ. The light in a state of which the focus point P depending on the wavelength λ is distributed continuously on the optical axis A is called as the focused light having axial chromatic aberration, herein. FIG. 1 schematically shows a state in which the white light W containing light ranging from wavelength λ1 to wavelength λ6 is converged respectively to focus positions P1 to P6, that are different from each other, depending on each wavelength. When the white light W is visible light of 500 to 700 nm, the focus position P1 shown in FIG. 1 is a focus position of visible light having the shortest wavelength λ1 (e.g., green light), and the focus position P6 is focus position of a visible light having the longest wavelength λ6 (e.g., red light), by positive dispersion of the chromatic aberration lens 26.

Distances from the probe main body 12 to the focus positions P1 to P6 are represented as L1 to L6. The range from the minimum value (distance L1) to the maximum value (distance L6) of these distances is the measurement range of the CPS probe 10.

FIG. 1 shows a state in which the workpiece is disposed in the measurement range of the CPS probe 10. For example, when the workpiece surface coincides with the focus position P2, the chromatic aberration lens 26 forms a measurement spot by light having the wavelength λ2 that focuses on the workpiece surface at the focus position P2. Light that reflected off this measurement spot (reflected light having the wavelength λ2) is focused again at the aperture AP by the chromatic aberration lens 26. The confocal optical system configured with the aperture AP and the chromatic aberration lens 26 can guide the light having the wavelength λ2 that reflected off the workpiece surface at the focus position P2 among the white light W to the optical fiber (a). Although a part of the white light W other than the wavelength λ2 also enters the aperture AP by the chromatic aberration lens 26, the amount of light is small because it is not focused at the workpiece surface. Therefore, the light having the wavelength λ2 that is focused at the workpiece surface becomes the strongest among light that enter the aperture AP.

This principle holds true no matter where the surface of the workpiece is positioned within the measurement range. For example, when the workpiece surface is at the focus position P3, the measurement spot is formed by light having the wavelength λ3, so that the reflected light of the wavelength λ3 is focused again at the position of the aperture AP. Light that entered the aperture AP is guided to the CPS detector as the measurement light M. The focus positions P1, P2, etc., within the measurement range on the optical axis A and the wavelengths λ1, λ2, etc., of the measurement light M are in a one-to-one correspondence. In other words, the distances L1, L2, etc., from the CPS probe 10 to the workpiece and the wavelengths λ1, λ2, etc., of the measurement light M are in a one-to-one correspondence.

The CPS detector 20 is a photodetector having spectral functions, and disperses the receiving measurement light M by a light dispersing element such as a diffraction grating to detect the dispersed light by a linear array detector. The light dispersing element guides the measurement light M in a direction depending on its wavelength. The direction of travel of the light from the light dispersing element differs depending on the wavelength, and multiple detection elements of the linear array detector are disposed to cover all of those directions. Therefore, the wavelength λ of the light having the maximum intensity contained in the measurement light M can be distinguished by the position of the detection element of the maximum light intensity signal.

The signal processing circuit 22 distinguishes the wavelength λ of the light having the maximum intensity, i.e., the distance L from the irradiation port of the probe main body 12 to the workpiece surface, based on the light intensity signal from the CPS detector 20, and outputs as distance information to the computer. Moreover, the signal processing circuit 22 outputs the light intensity signals of each detection element to the computer, in response to the request from the computer.

Instead of the above-described chromatic aberration lens 26, a diffraction optical element (DOE) may be used as the chromatic aberration optical element. Diffraction phenomenon at the DOE occurs by a minute structure formed on the surface of the optical element, and an optical length may be shortened than with a lens. Due to negative dispersion characteristic of the condensing-type DOE, distribution of focus positions becomes opposite to that of FIG. 1. That is, the focus position P1 of FIG. 1 becomes the focus position of the visible light having the longest wavelength λ6, and the focus position P6 becomes the focus position of the visible light having the shortest wavelength λ1.

### Configuration of CPS Measuring Apparatus

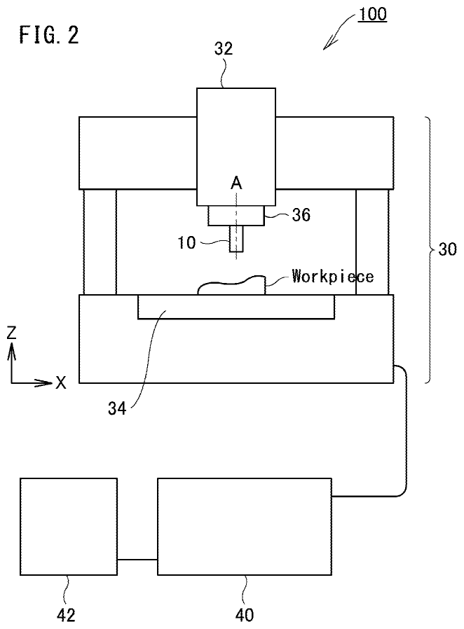

FIG. 2 schematically shows a configuration example of a CPS measuring apparatus 100. The CPS measuring apparatus 100 comprises the above-described CPS probe 10, a measuring apparatus main body 30, and a computer 40 connected to the main body 30 and the CPS probe 10. The measuring apparatus main body 30 includes a probe moving apparatus 32 that moves the CPS probe 10 relatively to the workpiece, and a table 34 where the workpiece is placed on.

The probe moving apparatus 32 is an apparatus that moves the CPS probe 10 mounted to a probe head 36 in directions of X-Y-Z axes relatively to the workpiece, and is configured with a Y-direction slider, an X-direction slider and a Z-direction slider, for example. Driving control of these sliders is executed by a function of the computer 40. Moreover, position detection sensors are provided in each moving direction, so that position information of each slider can be detected. Therefore, the probe moving apparatus 32 can output the position information to the computer 40 as the position information of the CPS probe 10. The probe moving apparatus 32 is not limited to the above-described configuration. For example, as for the Y-axis direction, the table 34 may be configured to be movable.

The computer 40 can calculate workpiece shape information based on the position information of the CPS probe 10 and the distance information from the CPS probe 10 to the workpiece. The computer 40 is an information processing device connected to the CPS probe 10 and the measuring apparatus main body 30 in a wired or wireless manner, and may built by combining multiple information processing devices, for example. Moreover, the computer 40 includes a monitor 42 for displaying the observation image.

### Configuration of Optical System for Observation

Going back to FIG. 1, a configuration of an observation unit 50 of the CPS probe 10 is described.

The probe main body 12 further has a dichroic mirror 28 provided inside the housing 24, the observation unit 50, and a connection portion 62 for connecting the observation unit 50 to the probe main body 12 detachably. The dichroic mirror 28 is disposed on the optical axis A between the chromatic aberration lens 26 and the aperture AP. The dichroic mirror 28 has wavelength selectivity, and has a characteristic of transmitting light in a wavelength region of 500 to 700 nm, and reflecting light in a wavelength region of less than 500 nm.

The observation unit 50 has a light source 52 for observation, a half mirror 54, a camera 56 for observation, a mirror 58 for camera, and a housing 60 that stores the light source 52, the half mirror 54, the camera 56 and the mirror 58. The observation unit 50 is configured as a one unit, and can be handled integrally.

An optical axis B of the observation unit 50 is approximately perpendicular to the optical axis A of the white light W of the probe main body 12 at the position of the dichroic mirror 28. On this optical axis B of the observation unit 50, the half mirror 54 and the mirror 58 for camera are disposed. An optical axis of the light source 52 for observation is approximately perpendicular to the optical axis B of the observation unit 50 at the position of the half mirror 54. An optical axis of the camera 56 for observation is approximately perpendicular to the optical axis B of the observation unit 50 at the position of the mirror for camera 58.

The light source 52 for observation uses an LED that emits an illumination light N (purple light) having a wavelength of about 430 nm, for example. Although the wavelength of the illumination light N is not limited, any wavelength that is not contained in the wavelength region of the white light W (500 to 700 nm) may be adopted. For example, a single wavelength of red light that is out of the wavelength region to the long wavelength side may be used. Not limited to visible lights, the illumination light N in the infrared region may also be used. Moreover, other solid light sources and lamps may be used as the light source 52 for observation.

The camera 56 for observation is one in which numerous pixels are aligned planarly like an image sensor, for example, and a CMOS area sensor or a CCD area sensor may be used. It is sufficient for the camera 56 for observation so long as it can at least detect light in a wavelength region of the illumination light N and output light intensity signals for each pixel.

The configuration of the observation optical system inside the observation unit 50 is not limited to the configuration described above, and it may be one that an optical element such as a lens is added, or may have an optical system that is designed optionally.

The connection portion 62 may be configured with an engagement hole or an engagement groove formed near an opening on the probe main body 12 side, and an engagement projected portion formed near an opening on the observation unit 50 side, for example. Upon connection, they are engaged to fix the observation unit 50 to the probe main body 12 with a screw. This configuration of the connection portion 62 is merely an example, and other configurations may be adopted. Furthermore, the connection portion 62 may include a mechanism capable of finely adjusting the optical axis B of the observation unit 50 relative to the optical axis A of the probe main body 12 (e.g., a fine-adjustment mechanism by a screw as described above).

About 50% of the illumination light N from the light source 52 for observation reflects off in a direction that is approximately perpendicular by the half mirror 54, passes through the opening of the connection portion 62, and enters the dichroic mirror 28. Due to wavelength selectivity, the dichroic mirror 28 transmits the white light W (500 to 700 nm) from the aperture AP, but reflects the illumination light N (430 nm) from the observation unit 50, and makes travel direction of the illumination light N to coincide with the optical axis A of the white light W.

The chromatic aberration lens 26 converts the white light W into focused light showing axial chromatic aberration to irradiate the workpiece. Moreover, the chromatic aberration lens 26 condenses the illumination light N to irradiate a specific region (illumination area) of the workpiece. Moreover, the chromatic aberration lens 26 condenses the light including the reflected light from the measurement spot on the workpiece surface and the reflected light from the illumination area to make the light enter the dichroic mirror 28. The dichroic mirror 28 transmits the reflected light (light within the wavelength region of 500 to 700 nm) from the measurement spot, and send the reflected light back to the aperture AP. Moreover, the dichroic mirror 28 reflects the reflected light (430 nm) from the illumination area, and send the reflected light back to the observation unit 50. The reflected light that returned to the observation unit 50 enters the half mirror 54 along the optical axis B as observation light K. Then, about 50% of the observation light K that transmits through the half mirror 54 reflects off the mirror 58 for camera and enters the camera 56 for observation.

### Monitoring Observation Image

The computer 40 is configured to execute driving control of the CPS light source 18 and the light source 52 for observation, and outputs a control signal for an amount of emitted light or timing of light emission of each light source 18, 52 to drive each light source 18, 52. Moreover, the computer 40 receives an output signal from the camera 56 for observation, generates an observation image of a measurement position on the workpiece to display the observation image on an external monitor. The observation image is an image expressed with shading based on the observation light K of single wavelength (430 nm), and is an image captured along the same axis as the optical axis A of the CPS probe 10.

### Mark Displaying Programs

The computer 40 of FIG. 2 functions as a mark displaying means. Mark displaying programs executed by the computer 40 are programs for displaying a geometric figurative image (mark) simultaneously with the observation image at the position corresponding to the measurement spot on the observation image. Specifically, the programs make the computer 40 to execute a mark position determining function, a mark displaying function and a shift amount confirming function. These programs are stored in a memory apparatus that configures the computer 40. The computer 40 can automatically execute these programs along with execution of CPS measurement, or can selectively execute these programs by measurement conditions set by a user.

### Method for Determining Mark Position

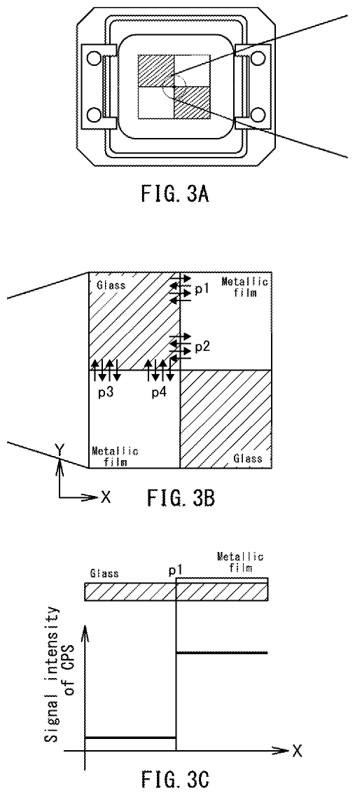

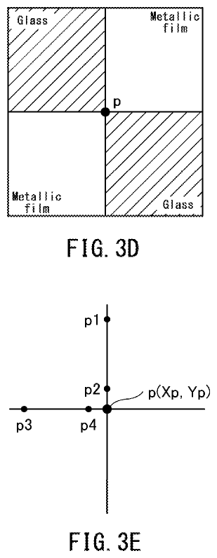

Operations of a program for determining a mark position using a chart for calibration shown in the plan view of FIG. 3A is described. In this chart for calibration, a geometric-shaped chart (pattern) is formed by a metallic film (e.g., a chromium film) on a glass substrate. As shown in the enlarged view of FIG. 3B, the chart for calibration has a boundary line between the glass and the metallic film parallel to Y-direction, a boundary line between the glass and the metallic film parallel to X-direction, and an intersection point of these boundary lines. The reason for utilizing the chart for calibration is because the computer 40 can easily recognize the position of the intersection point of the two boundary lines (position on X-Y plane) by image-processing the observation image. In addition, it is because coordinate information of any two points on each boundary line can be easily acquired by CPS measurement.

First, with respect to the chart for calibration placed on the table 34, two points (p1, p2) on the boundary line in Y-direction and two points (p3, p4) on the boundary line in X-direction are set as a target of scan measurement.

Next, scan measurement is executed by using the CPS probe 10. Scan measurement is to continuously execute CPS measurement by the measurement spot while the CPS probe 10 is moved to a direction perpendicular to the boundary line for each point. Moreover, by repeating scan measurement to the same point for multiple times to calculate an average, coordinate information of that point may be acquired.

FIG. 3C is a vertical cross-sectional view of the chart for calibration at a point p1. Since reflectivity is different on the glass surface and the surface of the metallic film, difference occurs between the signal intensities of the CPS detector 20 when CPS measurement is performed to each surface. Therefore, as shown in the graph of FIG. 3C, the coordinate information of the point p1 can be calculated based on change in the signal intensity of the CPS detector 20 during scan measurement. The coordinate information of other points p2, p3, and p4 are also acquired in such way.

Next, the coordinate information of the intersection point p of the two boundary lines shown in FIG. 3D is calculated based on the coordinate information of the four points (p1 to p4). Like FIG. 3E, for example, a parameter of the straight line that passes the point p1 and the point p2 is calculated, a parameter of the straight line that passes the point p3 and the point p4 is calculated, and these parameters are used to calculate the coordinate information (Xp, Yp) of the intersection point p. The computer 40 functions as a position recognizing means of the intersection point p in such way.

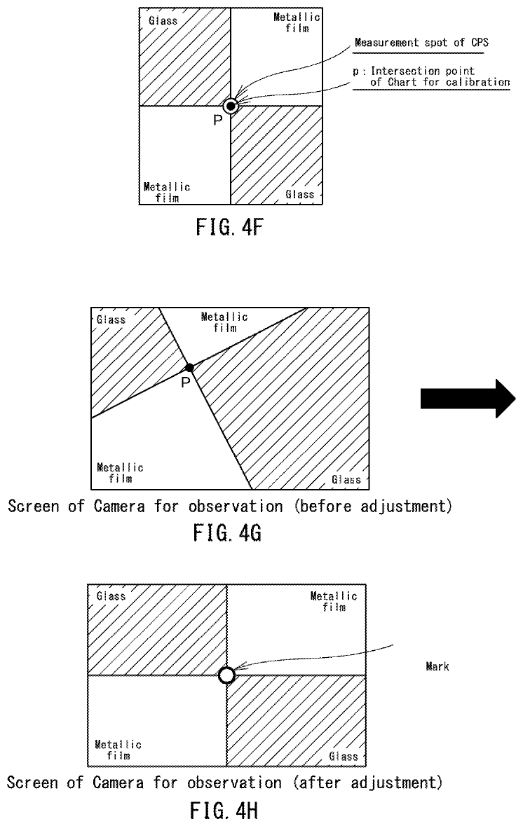

Next, the CPS probe 10 is moved to the intersection point p of the chart for calibration by using the calculated coordinate information (Xp, Yp). In accordance with this operation, the measurement spot by the CPS probe 10 moves to the intersection point p as shown in FIG. 4F. The plan views of the chart for calibration of FIGS. 3A, 3B, 3D, and FIG. 4F are those that illustrated the state when the user sees the chart for calibration placed on the table directly from the front. The measurement spot formed on the chart is not one that can be observed clearly like in FIG. 4F, and it may not be observed, or may be vague.

In this state, the light source 52 for observation and the camera 56 for observation are switched on to acquire the observation image of the chart for calibration. The observation image displayed on the monitor 42 is shown in FIG. 4G. The intersection point p of the chart for calibration is displayed within the field of view of the observation image (i.e., the illumination area); however, it may be displayed offset from the center to the upper left direction of the field of view, as in FIG. 4G. Moreover, vertical and horizontal directions of the rectangular field of view do not coincide with X, Y directions of the chart for calibration, and the field of view may be displayed in an inclined direction. In such case, the user may adjust the mounting posture of the observation unit 50 to make the intersection point p align with the center of the field of view, as in FIG. 4H or resolve inclination of the field of view, for example.

Lastly, by image-processing the observation image, the position of the pixel on the observation image that corresponds to the intersection point p of the chart for calibration is identified, and a mark is displayed on the identified pixel. The mark may be any geometric figurative image such as a circular shape, annular shape or cross shape. The computer 40 functions as the mark displaying means in such way.

The above-described operations are achieved by executing a determination program of the mark position, except for setting and adjustment performed by the user. By executing such operations for determining the mark position, the mark can be displayed correctly at the position of the measurement spot on the observation image.

According to the CPS measuring apparatus 100 of the present embodiment, the user can easily confirm the position of the measurement spot on the observation image by display of the mark. In particular, the user can easily confirm the measurement position during CPS measurement by the mark displayed on the observation image regardless of the distance from the CPS probe 10 to the workpiece during CPS measurement.

Not limited to the chart for calibration, a pattern member having some kind of pattern may be utilized to determine the mark position similarly. Or, a workpiece having some kind of shape capable of identifying one point, such as a projected portion or a recessed portion, may be used to determine the mark position similarly. The position of such one point needs to be recognizable by image processing of the observation image, and recognizable based on the detection signal of CPS measurement. For example, the one point may be formed such that the position of the one point can be identified by combining patterns of different reflectivity, such as shading, and may be formed so that the position of the one point can be identified by combining patterns with height differences. In the example of the chart for calibration described above, the function of recognizing the position of the intersection point p of the two boundary lines is described; however, scan measurement may be performed to the projected portion formed on the workpiece by the CPS probe 10, so that the coordinate information of the projected portion may be acquired directly.

Moreover, if there is a step between the glass surface and the surface of the metallic film when the coordinate information of one point such as the intersection point p of the chart for calibration is to be acquired, edge detection utilizing change in the wavelength of light that is detected by the CPS detector 20 (i.e., change in the detected distance information) may be executed instead of edge detection utilizing change in the signal intensity of the CPS detector 20.

### Method for Confirming Shift Amount

Next, operation of a program for confirming a shift amount between the position of the measurement spot and the position of the mark is described. This operation can be utilized for verifying whether the determined position of the displayed mark coincides with the actual measurement spot. Here, the chart for calibration that is the same as FIG. 3A is used; however, the intersection point p is not essential, and a pattern member or workpiece having at least one boundary line on the surface is sufficient. Such boundary line needs to be recognizable by image processing of the observation image, and recognizable based on the detection signal of CPS measurement.

First, a boundary line in Y-direction of the chart for calibration is set as a target of scan measurement.

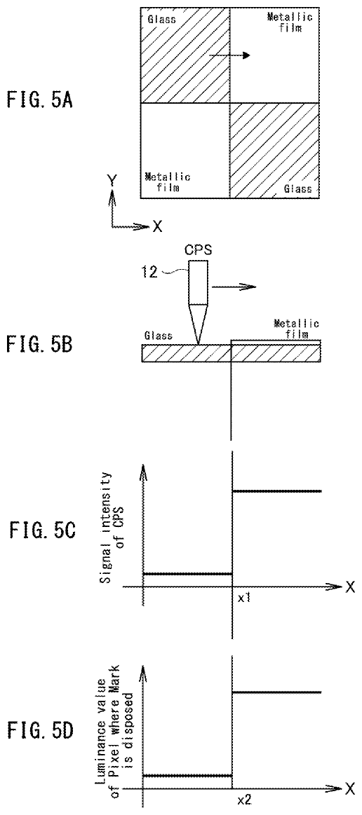

Next, while executing acquisition of the observation image, scan measurement of the CPS probe 10 is executed. In this scan measurement, while the CPS probe 10 is moved in a direction perpendicular to the boundary line of Y-direction as in FIG. 5A, CPS measurement by the measurement spot is continuously executed.

The vertical cross-sectional view of FIG. 5B shows positional relationship of the chart for calibration and the CPS probe 10.

FIG. 5C is a graph of a signal intensity of the CPS detector 20 by CPS measurement, and FIG. 5D is a graph of a luminance value that is detected by the pixel of the camera 56 for observation corresponding to the mark displaying position on the observation image.

Here, if the timing at which the position of the boundary line is recognized by CPS measurement and the timing at which the luminance value (amount of light received) of the pixel of the camera 56 for observation corresponding to the mark displaying position changes coincides, it can be said that the shift amount is zero. However, when there is a difference between the timings, there is a shift between the position of the measurement spot and the position of the mark. That is, the shift amount can be confirmed easily with high precision based on the difference between the timing at which the position of the boundary line is recognized by CPS measurement and the timing at which the amount of light received at the pixel of the camera 56 for observation that is at the position corresponding to the mark displaying position changes. Accordingly, the computer 40 functions as the shift amount confirming means. If the shift amount exceeds the standard, the position of displaying the mark is determined again.

When X coordinate of the boundary line based on change in the signal intensity of the CPS detector 20 is x1 as shown in FIG. 5C and X coordinate of the boundary line based on change in the luminance value of the pixel of the camera 56 for observation corresponding to the mark displaying position is x2 as shown in FIG. 5D, the difference (|x1−x2|) between positions of each measurement becomes the shift amount.

When there is a step between the glass surface and the surface of the metallic film like the boundary line of the chart for calibration, edge detection utilizing change in the wavelength of light detected by the CPS detector 20 (i.e., change in the detected distance information) may be executed instead of edge detection utilizing change in the signal intensity of the CPS detector 20.

As described above, the mark is displayed at the position of the measurement spot on the observation image in the first embodiment, so that the user can easily confirm the position of the measurement spot on the observation image regardless of the distance from the workpiece to the CPS probe 10 at CPS measurement. In addition, the position of displaying the mark should be determined once, and the mark is always fixed to one point on the observation image regardless of the movement of the CPS probe 10.

Moreover, in the first embodiment, light having a wavelength (less than 500 nm) that is not contained in the wavelength region of the white light W for CPS measurement (500 to 700 nm) is used as the observation light K, so that the dichroic mirror 28 can be used as a light splitting element. Compared to a beam splitter, an advantage of the dichroic mirror 28 is that it can suppress loss of the amounts of the measurement light M and the observation light K.

Moreover, the advantage of the dichroic mirror 28 is that even when illumination light N of 430 nm, for example, is irradiated to the workpiece, the reflected light thereof does not transmit through the dichroic mirror 28, so that the distance information detected by the CPS probe 10 is not affected, and the workpiece observation can be performed during CPS measurement. For example, by driving the CPS light source 18 and the light source 52 for observation simultaneously, conditions of CPS measurement can be set and a measurement programing can be executed while confirming the observation image of the workpiece on the monitor 42. Moreover, the user can confirm measurement situation of the CPS measuring apparatus 100 that operates according to a part program by the vision on the monitor 42 in real time.

Not limited to a case of irradiating the white light W and the illumination light N simultaneously, the timings of irradiating each light may be controlled suitably. For example, after the illumination light N is irradiated and the illumination area is observed, the white light W may be irradiated instead of the illumination light N to perform CPS measurement to the workpiece.

On the other hand, when conditions regarding loss of the amount of light can be cleared, a beam splitter (e.g., a half mirror) may be used as the light splitting element in the first embodiment. In this case, for example, even when the illumination light N of 430 nm is irradiated to the workpiece and a part of the reflected light thereof transmits through the beam splitter to be detected by the CPS detector 20, the wavelength of 430 nm is out of the measurement range (500 to 700 nm) of the CPS probe 10, so that the distance information detected by the CPS probe 10 is hardly affected. Moreover, although the measurement spot is unclear, the measurement spot is captured on the observation image, so that the mark can be displayed on the position of the measurement spot.

### Second Embodiment

### <Method for Correcting Mark Position for Optical Axis Misalignment>

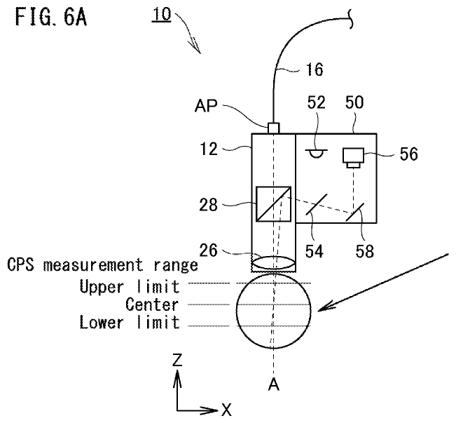

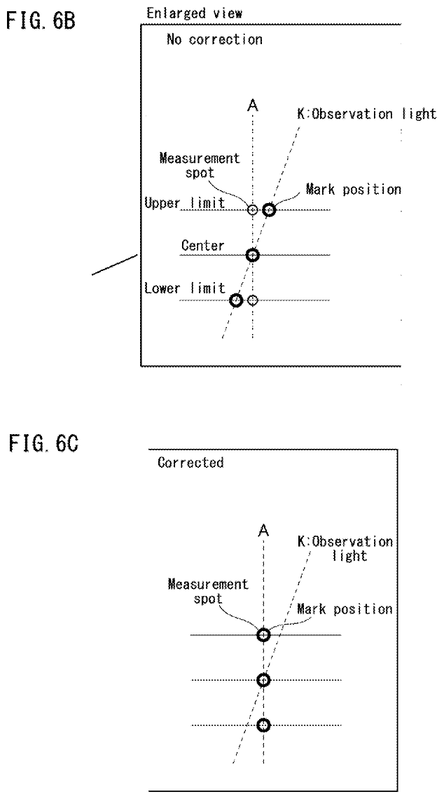

In the second embodiment, operation of a program that automatically corrects the mark position when an optical axis of the observation light K is misaligned relative to the optical axis A of the CPS probe 10, as shown in FIG. 6A, is described. Only the function of the computer 40 is different from the CPS measuring apparatus 100 of the first embodiment, and other configurations are the same.

FIG. 6B is an enlarged view of a positional relationship between the position of the measurement spot formed on the workpiece surface and the mark displaying position based on the determination method of the first embodiment at the upper limit, the center and the lower limit of the measurement range of the CPS probe 10 when optical axes are misaligned.

The optical axis A and the optical axis of the observation light K coincides at the center of the measurement range, so that there is no shift between the position of the measurement spot and the mark displaying position. However, there is a shift between the position of the measurement spot and the mark displaying position at the upper limit and the lower limit of the measurement range due to misalignment of the optical axis A and the optical axis of the observation light K.

Therefore, in the present embodiment, the computer 40 sets the distance from the CPS probe 10 to the intersection point p of the chart for calibration in multiple ways within the measurement range (axial chromatic aberration) of the CPS probe 10. Then, the position recognizing function and the mark displaying function of the computer 40 determine the position of displaying the mark on the observation image based on the position of the intersection point p for each set distance according to the determination method of the first embodiment. Then, the computer expresses the corresponding relationship between the distance from the CPS probe 10 to the workpiece and the mark displaying position in a tabular form to store a table of the corresponding relationship in a storage means.

At CPS measurement, the mark displaying function of the computer 40 reads out the mark displaying position from the stored table of the corresponding relationship based on the distance information to the workpiece of the measurement target acquired by the CPS probe 10. Then, the computer 40 displays the mark at the read-out displaying position on the observation image. Accordingly, the mark displaying position is corrected in response to the optical axes misalignment. The enlarged view of FIG. 6C shows that the mark displaying position after correction coincides with the position of the measurement spot.

### Third Embodiment

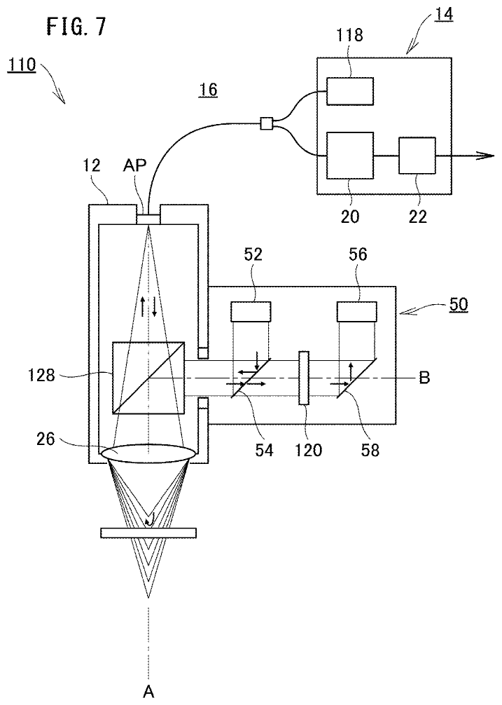

Next, configuration of the CPS measuring apparatus of the third embodiment is described. In the present embodiment, a CPS probe 110 shown in FIG. 7 is used. This CPS probe 110 uses a beam splitter 128 as the light splitting element.

Like the first embodiment, a purple light of 430 nm, for example, is used as the illumination light. Moreover, the wavelength region of the measurement range is set as 500 to 700 nm. Descriptions regarding other configurations that are the same as the configuration of the first embodiment are omitted.

On the other hand, the points different from the first embodiment other than the beam splitter 128 are that: a CPS light source 118 can output light in the wavelength region of less than 500 nm in addition to the wavelength region (500 to 700 nm) used in the measurement range, for example, the CPS light source 118 can output the white light W of 430 to 700 nm and a narrowband filter 120 (e.g., that transmits only light in a wavelength region of less than 500 nm) is disposed in front of the camera 56 for observation.

### Method for Determining Mark Position

For example, the light with the wavelength of 430 nm contained in the white light W from the CPS light source 118 can form a measurement spot at a position outside the measurement range (position closer to the probe main body 12 than the minimum measurement range). Therefore, by disposing the workpiece surface at the position of the measurement spot, a part of the reflected light of the measurement spot of 430 nm formed on the workpiece surface reflects off the beam splitter 128, travels inside the observation unit 50, passes through the narrowband filter 120, and enters the camera 56 for observation. Accordingly, since the measurement spot of 430 nm is captured on the observation image acquired by the camera 56 for observation, the mark may be displayed at the position of the measurement spot of 430 nm.

The illumination light from the light source 52 for observation is also the wavelength of 430 nm, and a part of the reflected light from the illumination area of the workpiece transmits through the beam splitter 128 and reaches the CPS detector 20; however, since the wavelength of 430 nm is out of the wavelength region of the measurement range of the CPS probe 110, output of CPS measurement is not affected.

### Other Embodiments

The present disclosure is not limited to the embodiments described above, and other various embodiments can be achieved.

### <Wavelength Region of CPS Light Source and Wavelength Region of Light Source for Observation May be the Same>

In the above, the wavelength region of the white light W for CPS measurement and the wavelength region of the illumination light N for observation are different; however, it is not limited thereto. For example, light of the same wavelength region as the white light W for CPS measurement may be used as the illumination light N. For example, in the configuration of the CPS probe 10 of FIG. 1, when the wavelength region of the CPS light source 18 is 500 to 700 nm, a white LED of the same wavelength region of 500 to 700 nm may be used as the light source 52 for observation. A beam splitter 128 is used as the light splitting element instead of a dichroic mirror 28. Accordingly, a color observation image of the workpiece can be generated based on output of the camera 56 for observation. Moreover, although the measurement spot is vague, the measurement spot is captured on the color observation image, so that the mark can be displayed at the position of the measurement spot.

When CPS measurement is affected by a part of the illumination light N transmitting through the beam splitter 128, it may be configured such that the computer 40 controls the timings of emitting lights of each light source 18, 52 such that the timings at which the CPS light source 18 and the light source 52 for observation emit the white light do not overlap.

### <Aperture for Detection May Be Disposed Separately From Aperture for Irradiation>

Moreover, in the above, the aperture AP of the CPS probe 10 is used as an opening for irradiating the white light W toward the chromatic aberration lens 26, and the aperture AP is also used as a focal point of the reflected light from the measurement spot; however, it is not limited thereto. For example, a branching element (beam splitter) that branches the reflected light from the workpiece from the optical axis A of the white light W may be further disposed inside the CPS probe 10 such that the reflected light may be guided to the optical axis to the CPS detector and focused at an aperture different from the aperture AP that irradiates the white light W.

With regards to the embodiments including the examples as described above, the following additional features are disclosed.

(Additional feature 1) A chromatic point sensor (CPS) measuring apparatus comprising a chromatic point sensor (CPS) probe that optically acquires distance information to a workpiece, a measuring apparatus main body that moves the CPS probe installed in a probe head relatively to the workpiece, and a computer that processes detection signal from the CPS probe to calculate a workpiece shape information,
wherein the CPS probe is provided to:
have an aperture that passes through light from a CPS light source, and a chromatic aberration optical element that converts the light that passed through the aperture into focused light having axial chromatic aberration to emit the focused light towards the workpiece, and form a measurement spot of wavelength depending on a distance to the workpiece on the workpiece surface that is positioned in a range of axial chromatic aberration of the focused light;
condense reflected light of the measurement spot with the chromatic aberration optical element and focus the reflected light at the aperture, and then guide the reflected light to a CPS detector so that the CPS detector outputs detection signals; and
irradiate illumination light from a light source for observation to an illumination area on the workpiece surface with the chromatic aberration optical element, and guide reflected light of the illumination area to a camera for observation via the chromatic aberration optical element; and
the computer has a function that displays a mark at a position of the measurement spot on an observation image acquired by the camera for observation.

(Additional feature 2) The CPS measuring apparatus of claim 1 comprising a workpiece having one point on a surface, and the position of the one point is image-recognizable on the observation image and recognizable based on the detection signals of the CPS detector, wherein
the computer further has a function that recognizes the position of the one point based on change in light intensity or change in a wavelength detected by the CPS detector by moving the measurement spot along the workpiece having the one point on the surface, and
the computer further has a function that moves the CPS probe to the recognized position of the one point, acquires an observation image of the one point by the camera for observation, and displays the mark at the position of the one point that is image-recognized from the observation image.

(Additional feature 3) The CPS measuring apparatus of claim 2, wherein
the workpiece having the one point on the surface is a pattern member having a pattern expressed with shading or height difference, and of which the position of the one point is identified by the pattern.

(Additional feature 4) The CPS measuring apparatus of any one of claims 1 to 3 comprising a workpiece having a boundary line on a surface, and the boundary line is formed to be image-recognizable on the observation image and recognizable based on detection signals of the CPS detector, wherein
the computer further has a function that confirms a shift amount between the position of the measurement spot and a display position of the mark, in which the computer recognizes the position of the boundary line based on change in light intensity or change in wavelength detected with the CPS detector by moving the measurement spot on the workpiece having the boundary line on the surface, in which the computer acquires the observation image of the boundary line with the camera for observation, and in which the computer confirms the shift amount based on difference between a timing at which the position of the boundary line is recognized and a timing at which an amount of light received at a pixel of the camera for observation placed at a position corresponding to the display position of the mark changes.

(Additional feature 5) The CPS measuring apparatus of any one of claims 2 to 4, wherein
the computer sets distances to the workpiece having the one point on the surface in multiple ways within the range of axial chromatic aberration,
the computer further has a function that determines the display position of the mark based on the position of the one point for each set distance to the workpiece, and stores each corresponding relationship between the distance to the workpiece and the display position of the mark, and,
the computer further has a function that when the distance information to the workpiece of a measurement target is measured by the CPS probe, reads out the display position of the mark depending on the distance information from the corresponding relationship, and displays the mark at the read-out display position.

(Additional feature 6) The CPS measuring apparatus of any one of claims 1 to 5, wherein a wavelength region of light output by the light source for observation and a wavelength region of light output by the CPS light source are different.

(Additional feature 7) The CPS measuring apparatus of any one of claims 1 to 6, wherein
a light splitting element configured with a dichroic mirror or a beam splitter is disposed between the aperture and the chromatic aberration optical element, and the illumination light from the light source for observation merges with light from the CPS light source by the light splitting element, and the reflected light from the illumination area is guided toward the camera for observation.

### DESCRIPTION OF REFERENCE NUMBERS

10 CPS probe
12 Probe main body
14 Light source/detection unit
16 Optical fiber portion
18 CPS light source
20 CPS detector
22 Signal processing circuit
24 Housing
26 Chromatic aberration lens
28 Dichroic mirror
30 Measuring apparatus main body
32 Probe moving apparatus
34 Table
40 Computer
42 Monitor
50 Observation unit
52 Light source for observation
54 Half mirror
56 Camera for observation
58 Mirror for camera
60 Housing
62 Connection portion
100 CPS measuring apparatus
110 CPS probe
118 CPS light source
120 Narrowband filter
128 Beam splitter
AP Aperture
M Measurement light
N Illumination light
K Observation light
W White light

1. A chromatic point sensor (CPS) measuring apparatus comprising: a chromatic point sensor (CPS) probe that optically acquires distance information to a workpiece; a measuring apparatus main body that moves the CPS probe installed in a probe head relatively to the workpiece; and a computer that processes detection signals from the CPS probe to calculate workpiece shape information,
wherein the CPS probe is provided to:
have an aperture that passes through light from a CPS light source, and a chromatic aberration optical element that converts the light that passed through the aperture into focused light having axial chromatic aberration to emit the focused light toward the workpiece, and form a measurement spot of wavelength depending on a distance to the workpiece on a workpiece surface that is positioned within a range of axial chromatic aberration of the focused light;
condense reflected light of the measurement spot with the chromatic aberration optical element and focus the reflected light at the aperture, and then guide the reflected light to a CPS detector such that the CPS detector outputs detection signals; and
irradiate illumination light from a light source for observation to an illumination area on the workpiece surface with the chromatic aberration optical element, and guide reflected light of the illumination area to a camera for observation via the chromatic aberration optical element, and
the computer has a function that displays a mark at a position of the measurement spot on an observation image acquired by the camera for observation.

2. The CPS measuring apparatus of claim 1 comprising a workpiece having one point on a surface, and the position of the one point is image-recognizable on the observation image and recognizable based on the detection signals of the CPS detector, wherein
the computer further has a function that recognizes the position of the one point based on change in light intensity or change in a wavelength detected by the CPS detector by moving the measurement spot along the workpiece having the one point on the surface, and
the computer has a function that moves the CPS probe to the recognized position of the one point, acquires an observation image of the one point by the camera for observation, and displays the mark at the position of the one point that is image-recognized from the observation image.

3. The CPS measuring apparatus of claim 2, wherein
the workpiece having the one point on the surface is a pattern member having a pattern expressed with shading or height difference, and of which the position of the one point is identified by the pattern.

4. The CPS measuring apparatus of claim 1 comprising a workpiece having a boundary line on a surface, and the boundary line is formed to be image-recognizable on the observation image and recognizable based on detection signals of the CPS detector, wherein
the computer further has a function that confirms a shift amount between the position of the measurement spot and a display position of the mark, in which the computer recognizes the position of the boundary line based on change in light intensity or change in wavelength detected with the CPS detector by moving the measurement spot on the workpiece having the boundary line on the surface, in which the computer acquires the observation image of the boundary line with the camera for observation, and in which the computer confirms the shift amount based on difference between a timing at which the position of the boundary line is recognized and a timing at which an amount of light received at a pixel of the camera for observation placed at a position corresponding to the display position of the mark changes.

5. The CPS measuring apparatus of claim 2, wherein
the computer sets distances to the workpiece having the one point on the surface in multiple ways within the range of axial chromatic aberration,
the computer further has a function that determines the display position of the mark based on the position of the one point for each set distance to the workpiece, and stores each corresponding relationship between the distance to the workpiece and the display position of the mark, and,
the computer further has a function that when the distance information to the workpiece of a measurement target is measured by the CPS probe, reads out the display position of the mark depending on the distance information from the corresponding relationship, and displays the mark at the read-out display position.

6. The CPS measuring apparatus of claim 1, wherein
a wavelength region of light output by the light source for observation and a wavelength region of light output by the CPS light source are different.

7. The CPS measuring apparatus of claim 1, wherein
a light splitting element configured with a dichroic mirror or a beam splitter is disposed between the aperture and the chromatic aberration optical element, and
the illumination light from the light source for observation merges with the light from the CPS light source by the light splitting element, and the reflected light from the illumination area is guided toward the camera for observation.

8. The CPS measuring apparatus of claim 2, wherein
a wavelength region of light output by the light source for observation and a wavelength region of light output by the CPS light source are different.

9. The CPS measuring apparatus of claim 3, wherein
a wavelength region of light output by the light source for observation and a wavelength region of light output by the CPS light source are different.

10. The CPS measuring apparatus of claim 4, wherein
a wavelength region of light output by the light source for observation and a wavelength region of light output by the CPS light source are different.

11. The CPS measuring apparatus of claim 5, wherein
a wavelength region of light output by the light source for observation and a wavelength region of light output by the CPS light source are different.

12. The CPS measuring apparatus of claim 2, wherein
a light splitting element configured with a dichroic mirror or a beam splitter is disposed between the aperture and the chromatic aberration optical element, and
the illumination light from the light source for observation merges with the light from the CPS light source by the light splitting element, and the reflected light from the illumination area is guided toward the camera for observation.

13. The CPS measuring apparatus of claim 3, wherein
a light splitting element configured with a dichroic mirror or a beam splitter is disposed between the aperture and the chromatic aberration optical element, and
the illumination light from the light source for observation merges with the light from the CPS light source by the light splitting element, and the reflected light from the illumination area is guided toward the camera for observation.

14. The CPS measuring apparatus of claim 4, wherein
a light splitting element configured with a dichroic mirror or a beam splitter is disposed between the aperture and the chromatic aberration optical element, and
the illumination light from the light source for observation merges with the light from the CPS light source by the light splitting element, and the reflected light from the illumination area is guided toward the camera for observation.

15. The CPS measuring apparatus of claim 5, wherein
a light splitting element configured with a dichroic mirror or a beam splitter is disposed between the aperture and the chromatic aberration optical element, and
the illumination light from the light source for observation merges with the light from the CPS light source by the light splitting element, and the reflected light from the illumination area is guided toward the camera for observation.
